(19) United States
(12) Patent Application Publication
(10) Pub. No.: US 2010/0156929 A1
(43) Pub. Date: Jun. 24, 2010

(54) Ridge-based color gamut mapping

(75) Inventors: Chung-Hui Kuo, Fairport, NY (US); Hwai-Tzuu Tai, Rochester, NY (US); Di Lai, Rochester, NY (US)

Correspondence Address: Andrew J. Anderson;Patent Legal Staff, Eastman Kodak Company, 343 State Street, Rochester, NY, 14650-2201, US

(73) Assignee: Eastman Kodak Company

(21) Appl. No.: 12/317,552

(22) Filed: Dec. 23, 2008

(51) Int. Cl. G09G 5/02

(52) U.S. Cl. 345/604

(57) ABSTRACT

Techniques for color gamut mapping between source and destination devices are provided. The mapping is performed in a device-independent color space using color ridges of the primary and secondary color ramps of the source and destination devices. An iterative learning process is also provided to adapt the color gamut mapping to a user's perceptual preferences.

### FIELD OF THE INVENTION

Exemplary embodiments of the invention are directed to converting between a source and destination device color space. More specifically, the present invention is directed to converting color spaces using color ridges of the source and destination device color gamuts, and to an iterative learning technique for modifying the conversion based on user preferences.

### BACKGROUND OF THE INVENTION

Color gamut is a visual representation of the color reproduction capability of an imaging device. Typically, there is a mismatch in color reproduction capabilities among the input and output devices. For example, the gamut of an image-capturing device adopting additive primaries, such as red, green, blue (RGB), is usually different from that of a printing device adopting subtractive primaries, such as cyan, magenta, yellow, black (CMYK). Color gamut mapping is employed for color image reproduction to address this mismatch of color reproduction capabilities.

Color gamut mapping typically requires converting the color gamuts of the source and destination devices into a device-independent, reference color space, such as the standard CIELAB or CIECAM02 color spaces. This can be achieved using lookup tables, commonly referred to as ICC profiles, and a color management module (CMM) performs an interpolation operation using the profiles to convert an image from a source device into the device-independent color space and to convert an image from the device-independent color space to the destination device. Alternatively, the color management module can convert images into and out of the device-independent color space using a list of color measurements for each device, a technique commonly referred to as “smart CMM”.

Once the device color spaces have been converted into the device-independent color space, the color gamuts can then be computed in the chosen color space, where the cusp of the gamut, focal points and border colors, can be identified. Hue information is preserved by applying a selected lightness and chroma compression strategy on the source gamut at each hue angle to match the destination color gamut. Alternatively, a hue shift of a set of border colors can be specified, the hue between two different border color points is linearly modified and lightness and chroma compression are applied.

### SUMMARY OF THE INVENTION

Although the CIELAB and CIECAM02 color spaces are intended to be perceptual color spaces, which are used to map color gamuts accounting for user perception, due to the complexities of the human visual system and how the human brain interprets colors, conventional gamut mapping techniques do not always accurately convert colors between different devices. Additionally, conventional techniques assume a certain illumination during color gamut mapping, whereas the viewing conditions and associated illumination levels may not conform to those assumed by the mapping technique. Finally, conventional techniques do not account for cultural and/or regional variations in the interpretation of color.

Exemplary embodiments of the invention overcome the above-identified and other deficiencies of conventional gamut mapping techniques by employing a color ridge-based mapping technique along with a learning process that modifies the mapping technique based on user preferences. Specifically, an exemplary method involves converting a source device color space into an independent color space to form a source color gamut and converting a destination device color space into an independent color space to form a destination color gamut. Colors of source color gamut are mapped in the independent color space to colors in the destination color gamut based on color ridges of the source and destination color gamuts, wherein the color ridges are intersections of primary or secondary colors in the source device color space or in the destination device color space that are traced within the independent color space. Information for converting an image from a source device color space to a destination device color space is generated based on the mapping.

An exemplary method can also involve receiving a selection of a portion of an image displayed on a source device and rendering a color ridge associated with the selected portion of the image on a destination device, wherein the color ridge is an intersection of primary or secondary colors in the source or destination device color space that is traced within an independent color space. A mapping of a color ridge of the source and destination device colors spaces is modified based on a perceptual preference of the rendered color ridge.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an exemplary graph illustrating the CIELAB color space;

FIG. 2A illustrates color ridges of a sRGB display and CMYK printer in the CIECAM02 color space;

FIG. 2B illustrates color ridges of a sRGB display and CMYK printer in the CIELAB color space;

FIGS. 3A and 3B respectively illustrate primary color ridges of red, green, blue (RGB) and cyan, magenta, yellow (CMY) gamuts in device color spaces;

FIG. 4A is a three-dimensional illustration of color ridges of a red, green, blue (RGB) display primary color ramps and color ridges of a cyan, magenta, yellow (CMY) printer primary color ramps;

FIG. 4B is a two-dimensional illustration of color ridges of a red, green, blue (RGB) display primary color ramps and color ridges of a cyan, magenta, yellow (CMY) printer primary color ramps;

FIGS. 5A and 5B illustrate an exemplary method of generating color association tables for gamut mapping in accordance with the invention;

FIG. 6 is a diagram illustrating an exemplary color ridge and anchor point mapping in accordance with the invention;

FIGS. 7A-7D illustrate exemplary tone scales in accordance with the present invention;

FIGS. 8A and 8B respectively illustrate gamut mapping from sRGB to CMYK in CIECAM02 and CIELAB color spaces in accordance with the invention;

FIGS. 9A and 9B illustrate an exemplary method of adapting gamut mapping based on user preference in accordance with the invention; and

FIG. 10 illustrates a table of values generated using the method of FIGS. 9A and 9B.

### DETAILED DESCRIPTION OF THE INVENTION

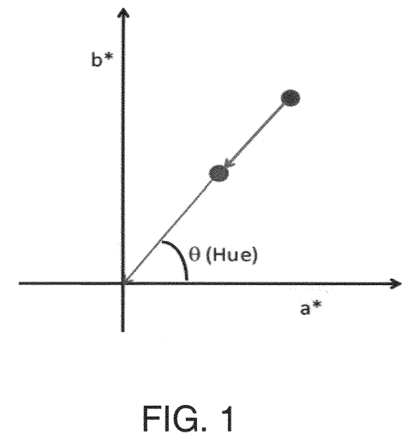

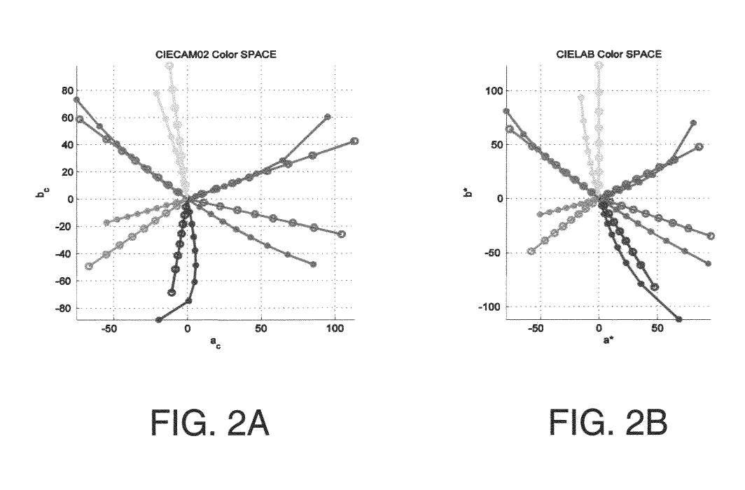

One major feature in the aforementioned gamut mapping algorithms is that they need to operate in a color space correlated with visual attributes such as hue and chroma. As illustrated in FIG. 1, in the CIELAB color space the hue is defined as the angle spanned by the a* axis and b* axis in the CIELAB space, where the a* axis defines a position between red/magenta and green, and the b* axis indicates a position between yellow and blue. Thus, typical hue preserving gamut mapping algorithms are constrained to map along the radial direction, which limits the amount of the gamut that is mapped. The gamut mapping results also depend on the operating color space. For example, as illustrated in FIGS. 2A and 2B the same trajectory has different numerical hue angles in different color spaces. In FIGS. 2A and 2B the lines with the open circles are ridges defined by a CMYK printer and the lines with the filled circles are ridges defined by a sRGB display. Thus, conventional gamut mapping techniques must be adjusted for the particular operating color space.

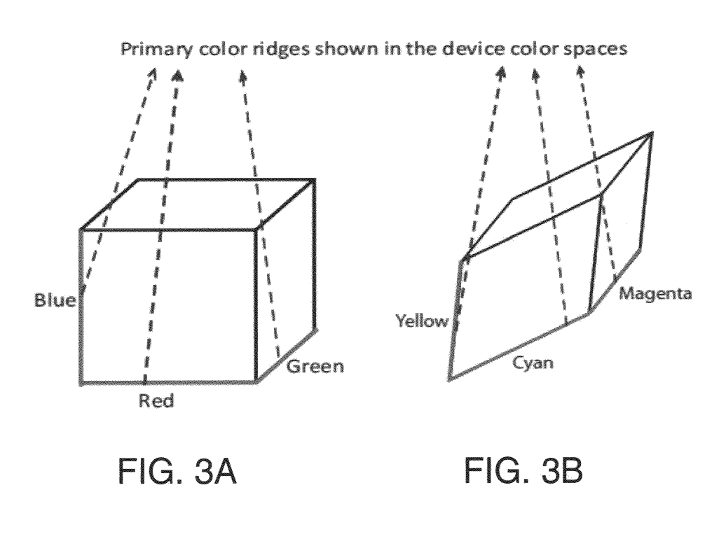

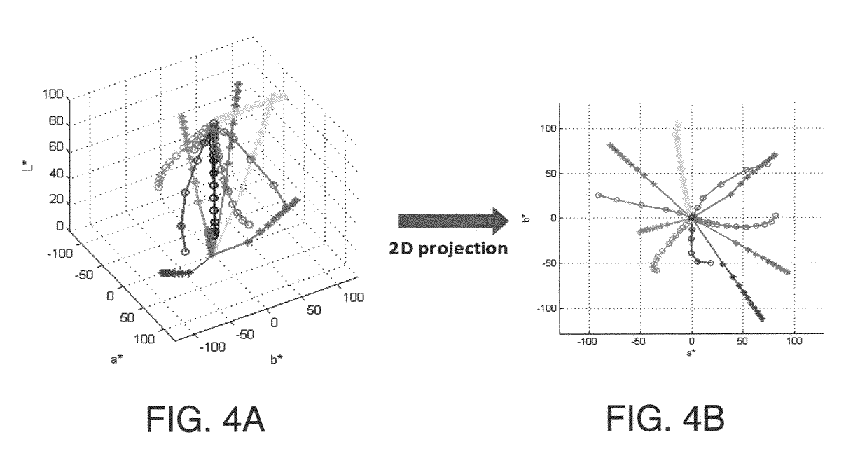

The present invention uses a gamut mapping process based on ridges on the color gamut surface within an operating color space (i.e., the device-independent color space) that align with the primary and secondary color ramps in the original source device color space or destination device color space. As used herein the term “ridge” signifies areas of intersection of primary or secondary colors in the source or destination device color space that are traced within the independent color space. FIGS. 3A and 3B respectively illustrate these ridges in a red, green, blue (RGB) device color space and a cyan, magenta, yellow (CMY) device color space. These ridges are illustrated in device-independent color spaces in FIGS. 4A and 4B. In these figures the lines with the open circles represent primary and secondary color ridges for a cyan, magenta, yellow, black (CMYK) printer device and lines with hash marks represent primary and secondary color ridges for an RGB display device. As will be discussed in more detail below, the color gamut mapping of the present invention maps the color ridges of the different devices in a device-independent color space, such as the CIELAB or CIECAM02 color spaces, by setting corresponding anchor points along the respective color ridges of the different devices. Accordingly, the same color gamut mapping technique can be used in different device-independent color spaces. As will also be described in more detail below, the color gamut mapping can be adjusted to suit user preferences by adjusting the anchor points used for mapping between color ridges.

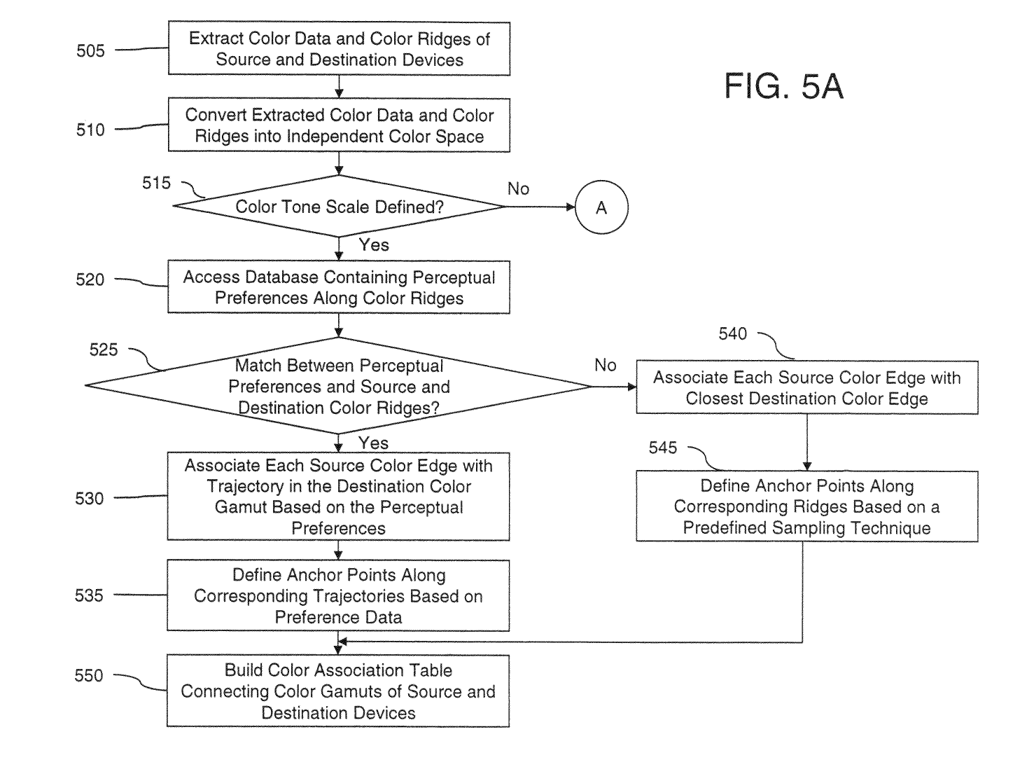

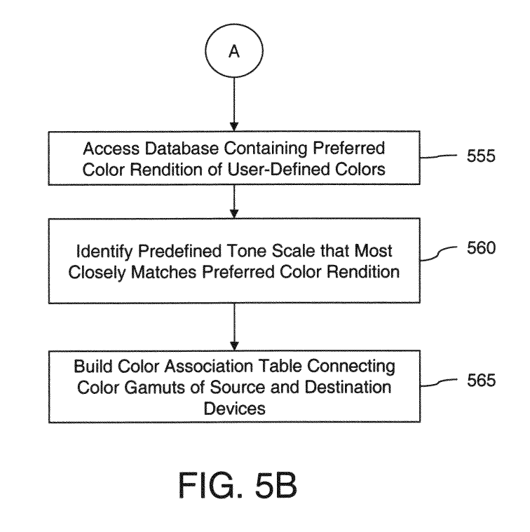

FIGS. 5A and 5B illustrate an exemplary method of generating color association tables for gamut mapping in accordance with the invention. The generated color association tables are used to map an image's color gamut within a device-independent color space. Initially, color data and color ridges of the source and destination devices are extracted (step 505) and are respectively converted into a device-independent color space (step 510). This can be performed by interpolation using ICC profiles or using a list of color measurements in a smart CMM technique. Next it is determined whether a color tone scale has been defined for both devices (step 515). Specifically, when the method is performed for the first time for a particular pair of source and destination devices there may not be a defined tone scale. However, it is also possible to use a tone scale defined between a similar pair of source and destination devices as a starting point.

When a color tone scale has been defined (“Yes” path out of decision step 515), then the ridge definition process is initiated by accessing a database containing perceptual preferences along color ridges (step 520) to determine whether there is a match between the perceptual preferences and the source and destination color ridges (step 525). The information in the database can be populated based on previous iterations of this method using the information generated using a predefined tone scale from steps 555-565, which are described in more detail below.

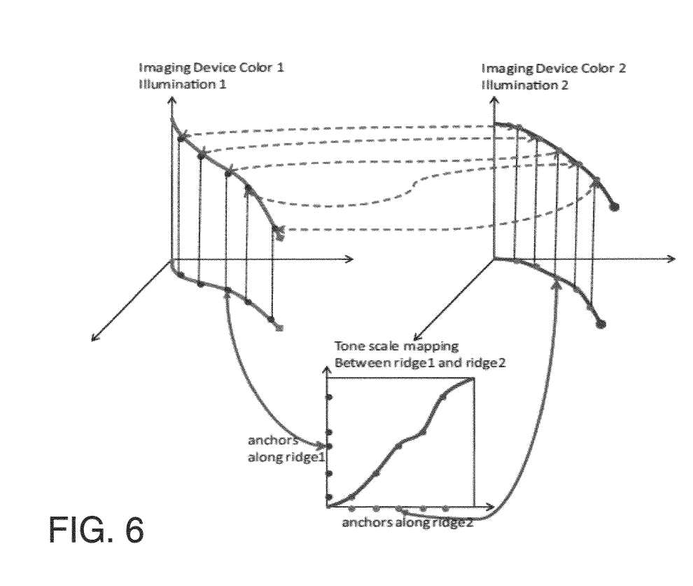

When a match exists between the perceptual preferences and the source and destination color ridges (“Yes” path out of decision step 525), then each source color edge is associated with a trajectory of an edge in the destination color gamut based on the perceptual preferences (step 530) and anchor points are defined along the corresponding trajectories based on the preference data (step 535). This is illustrated in FIG. 6 in which anchor points are assigned along color ridges of two different devices, each being viewed under a different illumination. The relative positions of the anchor points along each of the trajectories define the corresponding tone scale mapping. Thus, the tone scale can be easily adjusted along each trajectory by changing the location of each pair of corresponding anchor points based on user preferences.

Returning now to FIG. 5A, when a match does not exist between the perceptual preferences and the source and destination color ridges (“No” path out of decision step 525), then each source color edge is automatically associated the closest destination color edge (step 540) and anchor points are automatically defined along the corresponding trajectories based on a predefined sampling technique (step 545). The automatic association of edges and definition of anchor points will result in the graph illustrated in FIG. 6. After the anchor points have been defined (step 535 or 545), then a color association table is built using the anchor points to connect color gamuts of source and destination devices (step 550).

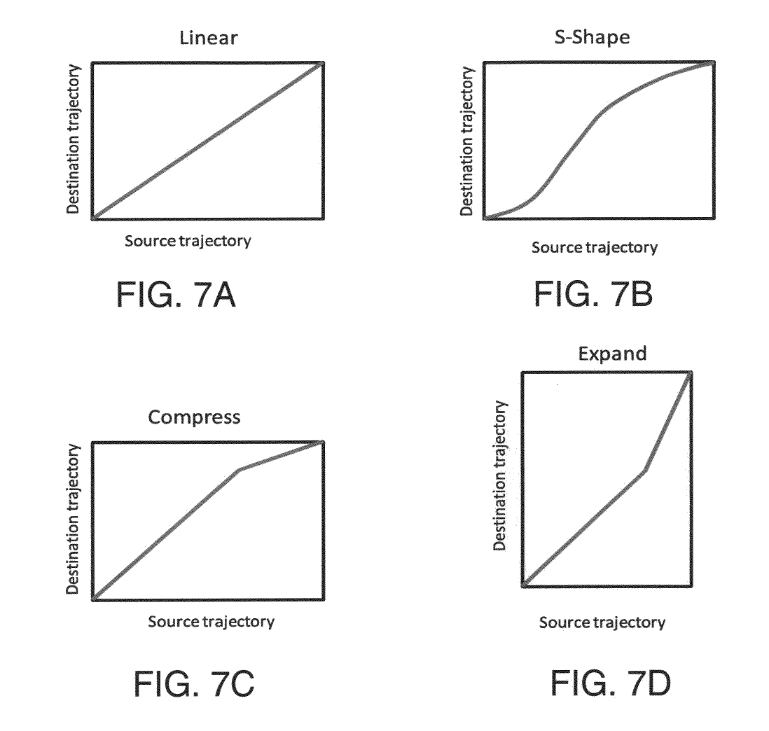

When the color tone scale is not defined (“No” path out of decision step 515), then the database containing the preferred color rendition of user-defined colors is accessed (step 555) and a predefined tone scale that most closely matches the preferred color rendition is identified (step 560). FIGS. 7A-7D illustrate four different color tone scales that can be employed with the present invention, however, the present invention can also use different color tone scales from those illustrated in FIGS. 7A-7D. The color association table is then built using the selected color tone scale to connect the color gamuts of the source and destination devices (step 565).

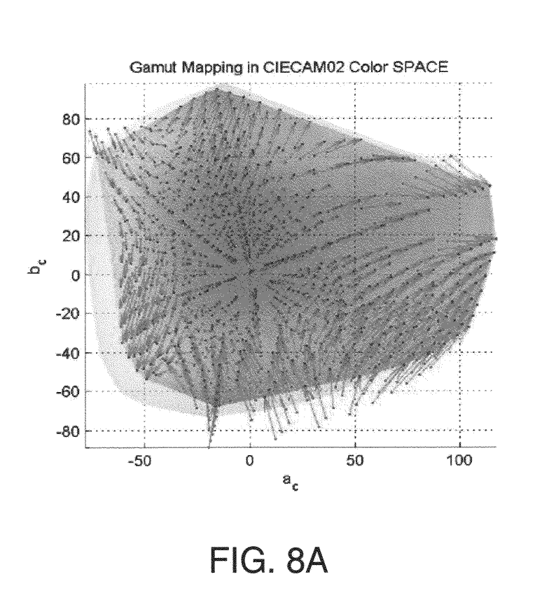

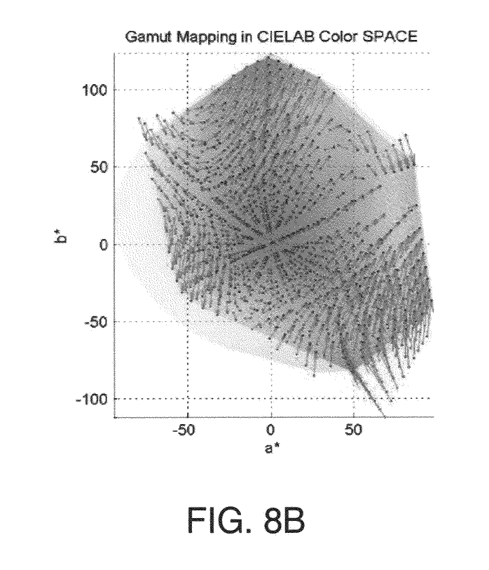

Exemplary gamut mapping from sRGB to CMYK in CIECAM02 and CIELAB color spaces using the method of FIGS. 5A and 5B is illustrated in FIGS. 8A and 8B. Because the gamut mapping technique of the invention does not require derivation of the actual color gamut description, but instead is only on the color ridge information, the color gamut does not vary depending upon which particular surface reconstruction algorithm is selected (e.g., convex hull, concave hull, alpha-shape, etc.). Additionally, because color ridges are often curves, the ridge-based mapping technique of the invention will be able to nonlinearly transform a source color gamut to a destination color gamut without being constrained by the hue angle, as is typically encountered using hue-preserving algorithms. Nonlinear transformation is particularly important because, for example, the primary red ridge for sRGB color encoding standard exhibits significant curvature at the most saturated segment, but remains relatively straight otherwise. Thus, unlike hue preserving algorithms, the ridge-based techniques of the invention significantly reduces any mismatch between the color trajectories along the primary and secondary color ramps between the source and destination device color gamuts, which results in primary and secondary colors being reproduced in a more saturated manner. Additionally, the tone scale along each color ridge can be adjusted independently, and accordingly the chroma expansion/compression can be adjusted independently in different color quadrants.

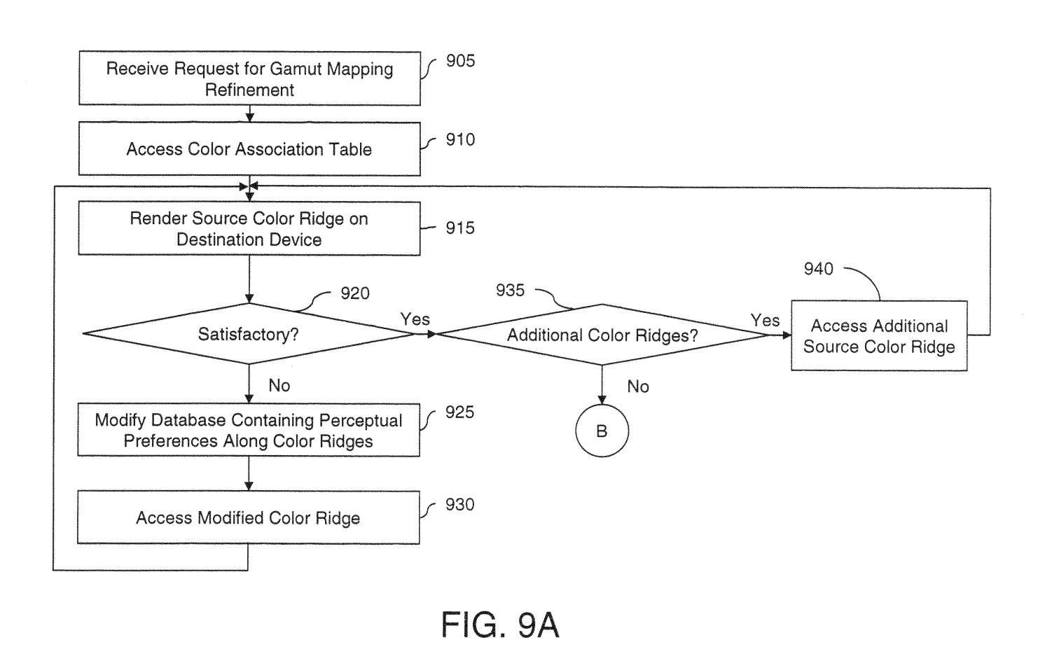

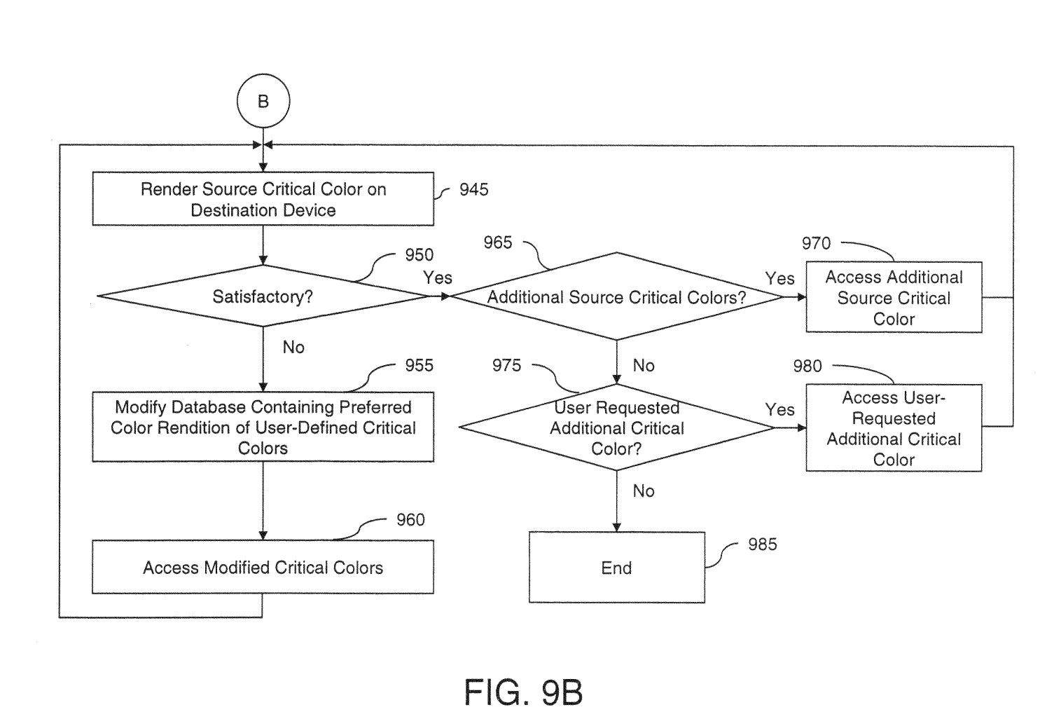

As briefly discussed above, exemplary embodiments of the present invention also provide for a learning process to adapt the color gamut mapping to conform to user preferences. An exemplary method is illustrated in FIGS. 9A and 9B. When a request for gamut mapping refinement is received (step 905), the color association table is accessed (step 910). For example, an image can be displayed to a user and the request can be based on a user selection of a group of pixels of the displayed image. A source color ridge is then rendered on the destination device (step 915). For example, a source color ridge associated with the user selected group of pixels can be rendered by a printer device on a piece of paper. The user can then decide whether the source color is satisfactorily rendered (step 920).

When a source color ridge has not been satisfactorily rendered on the destination device (“No” path out of decision step 920), then the database containing perceptual preferences is modified along the color ridges of the source and destination device by modifying the respective anchor points (step 925). For example, a user can indicate that a particular color should be made light or darker, or moved more in the direction of, or away from, a particular color shade. In response the color ridge is modified to accommodate the user's indicated preference. The modified color ridge is accessed from the database (step 930) and again rendered (step 915) for the user to determine whether it was satisfactorily rendered (step 920).

When the source color ridge is satisfactorily rendered (“Yes” path out of decision step 920), then it is determined whether additional color ridges associated with the selected pixels should be rendered (step 935). When additional color ridges should be rendered (“Yes” path out of decision step 935), the additional source color ridge is accessed (step 940), rendered on the destination device (step 915) for the user to determine whether the additional color ridge was satisfactorily rendered (step 920).

When there are no additional color ridges for potential adjustment (“No” path out of decision step 935), then, as illustrated in FIG. 9B, a source critical color is rendered on the destination device (step 945) and the user determines whether it was satisfactorily rendered (step 950). The user can previously define colors as being critical colors and the rendered critical color can be one that is within the user selected group of pixels. When the source critical color is not satisfactorily rendered (“No” path out of decision step 950), then a database containing preferred color rendition of user-defined critical colors is modified by adjusting anchor points of the color ridges that affect the particular critical color (step 955). The modified critical color is accessed (step 960) and then rendered on the destination device (step 945) for the user to determine whether it was satisfactorily rendered (step 950).

When the source critical color is satisfactorily rendered on the destination device (“Yes” path out of decision step 950), it is determined whether there are additional source critical colors for evaluation by the user (step 965). When there are additional source critical colors for evaluation (“Yes” path out of decision step 965), then the additional source critical colors are accessed (step 970), and rendered on the destination device (step 945) for determination by the user whether the color is satisfactorily rendered (step 950).

When there are no additional source critical colors for evaluation by the user (“No” path out of decision step 965), then it is determined whether the user has requested the addition of a source critical color (step 975). When the user has so requested (“Yes” path out of decision step 975), then the user-requested additional critical color is accessed (step 980), rendered on the destination device (step 945) for determination by the user whether the color is satisfactorily rendered (step 950). When, however, there is not a user request for additional critical colors (“No” path out of decision step 975), then the process ends (step 985).

The gamut mapping function approximation process of FIGS. 9A and 9B generally needs to achieve two objectives with minimal cost, satisfying the constraints imposed by the color association table and producing a gamut mapping function that is a smooth function. This can be achieved using a generalized regression neural network, a multi-dimensional spline and/or localized linear interpolation.

Although the method of FIGS. 9A and 9B illustrate performing the color ridge and critical color adjustments in a serial manner, these adjustments can be performed in parallel using the user-selected group of pixels.

The color association table generated using the methods of FIGS. 5A and 5B, and 9A and 9B can be used to convert images between source and destination devices by interpolation in place of ICC tables. Alternatively, the color association table can be used as a list of color measurements in connection with a smart CMM technique.

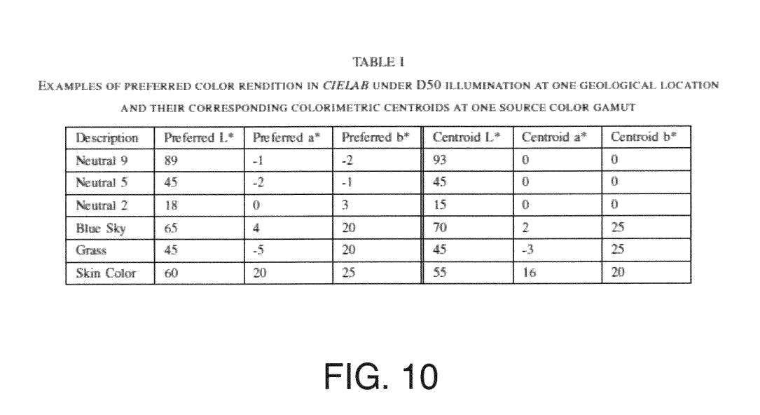

FIG. 10 illustrates an exemplary table generated using the learning process of FIGS. 9A and 9B under D50 illumination at one geographical location for one source color gamut. In this table the preferred values indicate those based on a user's perception and the centroid values represent calorimetric values. As illustrated in the table the preferred values can deviate from the colorimetric values based on the user's preference. In addition to the color ridges (i.e., Neutral 9, Neutral 5 and Neutral 2), the table also includes colors that are identified as critical by the user (i.e., blue sky, grass and skin color).

The methods described above can be performed on one or more processors, such as a microprocessor, field programmable gate array (FPGA), and/or an application specific integrated circuit (ASIC). When a microprocessor is employed instructions for executing the methods can be obtained from any type of suitable memory. The one or more processors can be included in the source device, destination device and/or a device that couples the source and destination devices (e.g., a computer).

The invention has been described in detail with particular reference to certain preferred embodiments thereof, but it will be understood that variations and modifications can be effected within the spirit and scope of the invention.

1. A method of generating mapping information for converting an image from a source device color space to a destination device color space, the method comprising:
converting a source device color space into an independent color space to form a source color gamut;
converting a destination device color space into an independent color space to form a destination color gamut;
mapping, in the independent color space, colors of source color gamut to colors in the destination color gamut based on color ridges of the source and destination color gamuts, wherein the color ridges are intersections of primary or secondary colors in the source or destination device color space that are traced within the independent color space; and
generating information for converting an image from a source device color space to a destination device color space based on the mapping.

2. The method of claim 1, wherein the mapping is performed using a color association table connecting color gamuts of the source and destination devices.

3. The method of claim 1, further comprising:
extracting color data and color ridges from the source and destination devices; and
converting the extracted color data and color ridges into the independent color space.

4. The method of claim 3, wherein the color association table is generated using information from a perceptual preference database.

5. The method of claim 4, wherein when there is a match between color ridges of the source and destination devices, the method comprising:
associating each source color edge with a preferred rendering trajectory; and
defining anchor points along corresponding trajectories based on the perceptual preferences.

6. The method of claim 4, wherein when there is not a match between color ridges of the source and destination devices, the method comprising:
associating each source color edge with a closest destination color edge; and
defining anchor points along corresponding ridges of the source and destination color edges.

7. The method of claim 4, wherein information in the perceptual preference database is generated by:
rendering a source color ridge on the destination device;
receiving feedback information regarding the rendered source color ridge on the destination device; and
modifying information in the perceptual preference database using the received feedback.

8. The method of claim 3, wherein the color association table is generated using a user-defined critical color database.

9. The method of claim 8, wherein information in the user-defined critical color database is generated by:
rendering source critical colors on the destination device;
receiving feedback information regarding the rendered source critical colors on the destination device; and
modifying information in the user-defined critical color database using the received feedback.

10. The method of claim 9, further comprising:
receiving an indication of additional critical colors; and
storing the additional critical colors in the user-defined critical color database.

11. The method of claim 1, wherein the information for converting an image from a source device color space to a destination device color space generated based on the mapping is used as a lookup table in an interpolation operation to convert an image from the source device color space to the destination device color space.

12. The method of claim 1, wherein the information for converting an image from a source device color space to a destination device color space generated based on the mapping is used as color measurements in a smart color management module to convert an image from the source device color space to the destination device color space.

13. The method of claim 1, wherein the source device uses a red, green, blue (RGB) color gamut and the destination device uses a cyan, magenta, yellow and black (CMYK) color gamut.

14. The method of claim 1, wherein the source device uses a cyan, magenta, yellow and black (CMYK) color gamut and the destination device uses a red, green, blue (RGB) color gamut.

15. A method of generating mapping information for converting an image from a source device color space to a destination device color space, the method comprising:
receiving a selection of a portion of an image displayed on a source device;
rendering a color ridge associated with the selected portion of the image on a destination device, wherein the color ridge is an intersection of primary or secondary colors in the source or destination device color space that is traced within an independent color space; and
modifying a mapping of a color ridge of the source and destination device colors spaces based on a perceptual preference of the rendered color ridge.

16. The method of claim 15, further comprising:
rendering a source critical color associated with the selected portion of the image on the destination device; and
modifying a mapping of the critical color between the source and destination device color spaces by adjust a mapping of a color ridge of the source and destination device colors spaces based on a perceptual preference of the rendered critical color.

17. The method of claim 16, wherein the rendering of the color ridge and source critical color and modification of the mapping of the color ridge and source critical color are performed in parallel.

18. The method of claim 15, wherein the mapping of the color ridge is used for converting an image from a source device color space to a destination device color space, wherein the mapping is used as a lookup table in an interpolation operation to convert an image from the source device color space to the destination device color space.

19. The method of claim 15, wherein the mapping of the color ridge is used for converting an image from a source device color space to a destination device color space, wherein the mapping is used as color measurements in a smart color management module to convert an image from the source device color space to the destination device color space.
